(19) United States
(12) Patent Application Publication
(10) Pub. No.: US 2008/0101374 A1
(43) Pub. Date: May 1, 2008

(54) PACKET FIFO

(75) Inventor: Matthew J. West, Salem, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company LP

(21) Appl. No.: 11/553,989

(22) Filed: Oct. 27, 2006

(51) Int. Cl. H04L 12/56; H04L 12/28

(52) U.S. Cl. 370/395.7; 370/412

(57) ABSTRACT

Various methods and apparatus are disclosed for reading or writing randomly accessible portions of a packet of data.

### BACKGROUND

Buffering of packetized data between different clock domains is sometimes performed using a first-in, first-out (FIFO) counter. Access to the packetized data is limited without utilizing more processing resources or processing time.

### BRIEF DESCRIPTION OF THE DRAWINGS

FIG. 1 is a schematic illustration of a data handling system according to an example embodiment.

FIG. 2 is a schematic illustration of a memory device of the system of FIG. 1 according to an example embodiment.

FIG. 3 is a schematic illustration of a portion of the data handling system of FIG. 1 illustrating a method for writing data according to an example embodiment.

FIG. 4 is a schematically station of a portion of the data handling system of FIG. 1 illustrating a method for reading data according to an example embodiment.

### DETAILED DESCRIPTION OF THE EXAMPLE EMBODIMENTS

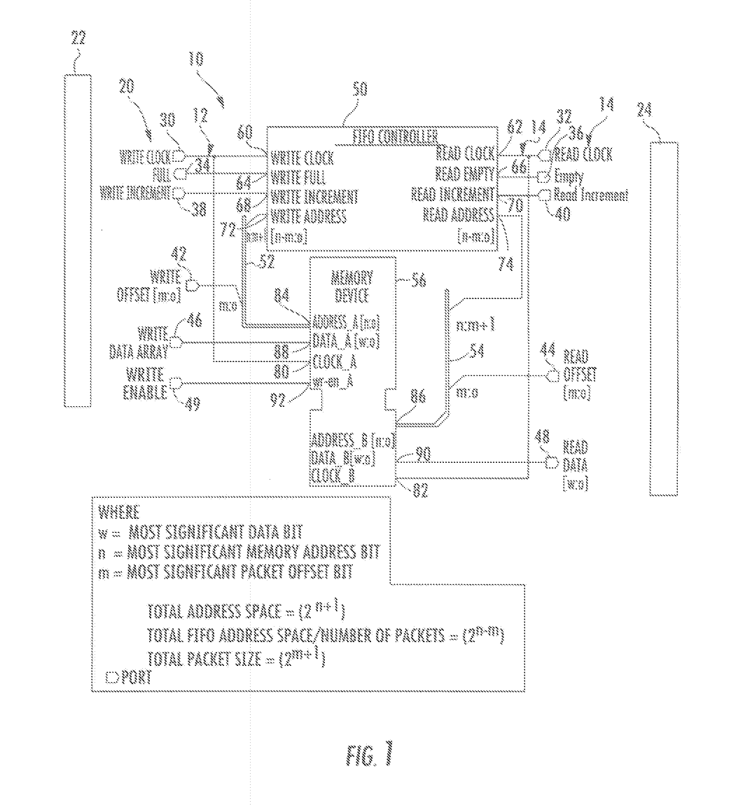

FIG. 1 is a schematic illustration of a data handling system 10 according to one example embodiment. Data handling system 10 is configured to store or otherwise buffer data, such as packetized data. In the particular example illustrated, system 10 is configured to buffer and transmit signals from a first domain 12 operating at a first clock frequency to a second domain 14 operating at a second distinct clock frequency using a first-in, first-out handling scheme. As will be described in more detail hereafter, system 10 enables selected portions of the packet being written using the (FIFO) scheme to be randomly accessed and written. System 10 further enables selected portions of a packet being read using the (FIFO) scheme to be randomly accessed and read. System 10 generally includes FIFO memory system 20 and one or more processing units 22, 24.

FIFO memory system 20 temporarily stores or buffers data packets. In the particular example illustrated, memory system 20 is embodied as part of a programmable logic device or other integrated circuit. A programmable logic device is a semiconductor integrated circuit having fabricated programmable logic and other functional portions such as random access memory (RAM). For example, data handling system 10 may be embodied as part of a field programmable gate array (FPGA) or an application specific integrated circuit (ASIC).

FIFO memory system 20 includes write clock port 30, read clock port 32, write full port 34, read empty port 36, write increment port 38, read increment port 40, write enable port 49, write offset port 42, read offset port 44, write data port 46, read data port 48, FIFO controller 50, write address bus 52, read address bus 54 and memory device 56. Write clock port 30 and read clock port 32 comprise inputs by which clock signals are supplied from domains 10 and 12, respectively, to controller 50 and memory device 56. Signals input via write clock port 30 control the timing at which controller 50 outputs signals to memory device 56 and also controls the timing at which data is written to memory device 56. Similarly, signals input via read clock port 32 control the timing at which controller 50 outputs signals to memory device 56 and also control the timing at which data is read from memory device 56.

Write full port 34 and read empty port 36 comprise ports by which signals from FIFO controller 50 are transmitted to the one or more processing units 22, 24. In particular, FIFO controller 50 utilizes write full port 34 to communicate to the processing unit 22 that memory device 56 is temporarily full such that data may not be written to memory device 56 for a particular clock cycle. Similarly, FIFO controller 50 utilizes read empty port 36 to communicate to processing unit 24 that memory device 56 is temporarily empty such that data may not be read from memory device 56 for a particular clock cycle.

Write increment port 38 and read increment port 40 comprise ports by which signals from the processing units 22 and 24, respectively, may be transmitted to FIFO controller 50 to increment the write and read counters or pointers of controller 50. As will be described in more detail hereafter with respect to controller 50, increment signals received via write increment port 38 increment as address of memory device 56 to be assigned by controller 50 to a particular packet of data being written to memory device 56. Similarly, increment signals received via read increment port 40 increment an address of memory device 56 provided by controller 50 from which a particular packet of data is to be read.

Write offset port 42 and read offset port 44 comprise ports by which signals are input to system 20 identifying the particular randomly accessible portion of a packet to which data is to be written or from which data is to be read. In particular, write offset port 42 identifies one of the portions of a packet to which data is to be written. Read offset port 44 identifies one of the portions of a packet from which data is to be read. Such signals to ports 42 and 44 is provided by one or more processors 22 and 24, respectively. As indicated by FIG. 1, the offset address extends from a most significant packet offset bit m to zero.

Write data port 46 and read data port 48 comprise ports by which data to be written to memory device 56 is supplied and by which data read from memory device 56 is transmitted. Write enable port 49 comprises a port by which signals are transmitted to memory device 56, enabling the writing of the data received via port 46 to be written to memory device 56. In other embodiments, the write domain 12 can have a read data port to facilitate additional processing efficiencies and resource reuse by processing unit 22. Likewise in yet other embodiments, the read domain 14 can have a write data port and a write enable port to assist in resource utilization by the processing unit 24.

FIFO controller 50 comprises a presently developed or future developed first-in, first-out logic device. For example, in one embodiment, FIFO controller 50 comprises an address counter that tracks read and write addressees being used. In one embodiment, controller 50 comprises a circular counter that wraps around to an initial address after the last address is accessed. In the particular example illustrated, controller 50 is configured to address different input ports of memory device 56, shown as a multi-port or dual port random access memory (RAM). In a particular embodiment illustrated, controller 50 is asynchronous in that controller 50 facilitates writing to memory device 56 and reading from memory device 56 by different domains having different clock rates or at the same clock rate but with an unknown phase difference or skew.

In the example illustrated, controller 50 includes a write clock pin or input 60, a read clock input 62, a write full output 64, a read empty output 66, a write increment input 68, a read increment input 70, a write address output 72 and a read address output 74. Inputs 60 and 62 are connected to ports 30, 32 and receive write and read clock signals, respectively. Output 64 and 66 are connected to ports 34 and 36 and output write full and read empty signals, respectively. Inputs 68 and 70 are connected to ports 38 and 40 and receive write increment and read increment signals, respectively. Outputs 72 and 74 are connected to address busses 52 and 54 and transmit a next available write address and a next available read address, respectively.

Controller 50 coordinates data flow into and out of memory device 56 to reduce the likelihood of memory not being available to accept incoming data, preventing overflow, and to also reduce the likelihood of a read operation being performed on an empty portion of memory device 56, preventing underflow. Controller 50 generates status flags or signals, such as FIFO full and FIFO empty flag, indicating when memory device 56 is full or empty. Such flags indicate whether or not sufficient space in memory device 56 exists for writing to occur or for reading to be performed.

Write address bus 52 comprises a group of signal lines, traces or wires extending between a write address output 72, write offset port 42 and memory device 56. Write address bus 52 joins signal communicating lines from write address output 72 and write offset port 42 such that the write address provided by write address output 72 and the offset address provided via write offset port 42 are concatenated prior to being transmitted to memory device 56. As a result, data being written to memory device 56 will be assigned an address having a first portion denoting a particular packet and a second portion denoting a particular randomly accessible portion of the packet.

Read address bus 54 comprises a group of signal lines, traces or wires extending between a read address output 72, write offset port 44 and memory device 56. Write address bus 54 joins signal communicating lines from read address output 74 and read offset port 44 such that the read address provided by read address output 74 and the offset address provided via read offset port 44 are concatenated prior to being transmitted to memory device 56. As a result, the address of the packet of data to be read from memory device 56 has a first portion denoting the packet to be read and a second portion denoting the particular portion of the packet which is to be read.

Memory device 56 comprises a persistent storage device to which data may be randomly written and from which data may be randomly read. In the particular example illustrated, memory device 56 comprises a dual port random access memory (RAM). In other embodiments, memory device 56 may be replaced with multiple individual memory devices, such as individual RAM chips, wherein system 20 may additionally include a chip counter to regulate access to individual chips. In yet other embodiments, other memory devices may be utilized.

As shown by FIG. 1, memory device 56 includes a write clock input 80, a read clock input 82, a write address input 84, a read address input 86, a write data input 88, a read data output 90, and a write enable input 92. Write clock input 80 and read clock input 82 receive clock signals from domains 12 and 14, respectively via ports 30 and 32, respectively. Such clock signals regulate the timing at which data is written to and read from memory device 56.

Write address input 84 and read address input 86 received address signals indicating where data is to be written or from where data is to be read. Write address input 84 is connected to address bus 52. Read address input 86 is connected to address bus 54. As indicated in FIG. 1, read and write addresses extend from the most significant memory address bit n to zero. In one embodiment, the address bits provided by controller 50 may be in a binary format. In another embodiment, the address bits provided by controller 50 may be in a Gray code format. In other embodiments, the address bits provided by controller 50 may be in some other deterministically sequential pattern.

Write data input 88 and read data output 90 comprise pins by which data is written to or transmitted from memory device 56. In particular, data to be written to a particular address of memory device 56 is input via input 88. Data in memory device 56 which has been read is transmitted via output 90. As indicated by FIG. 1, data being written to memory device 56 and data read from memory device 56 extends from a most significant data bit w to zero. In other embodiments the data bus width of ports 88 and 90 may be of differing widths. Although write data port 46 and read data input 88 are illustrated as separate structures, in other embodiments, they may be integrated as a single structure. Although read data port 48 and read the data output 90 are illustrated as separate structures, in other embodiments, they may be integrated as a single structure.

Write enable input 92 is connected to write enable port 49 and receives write enable signals. As noted above, such signals enable memory device 56 to be written to. Although write enable port 49 and write enable input 92 are illustrated as separate structures, in other embodiments, they may be integrated as a single structure.

As further indicated by FIG. 1, controller 50 provides packet write addresses [n-m-1:0], where n is the most significant memory address bit and where m is the most significant packet offset bit. Offset addresses [m:0] are provided via ports 42 and 44. These addresses are concatenated together by address busses 52 and 54 to form a concatenated address [n:0], where n is the most significant memory address bit. As a result, memory device 56 has a total address space equal to 2ⁿ⁺¹, the total number of packets in the FIFO address space is equal to 2^{n-m} and the total packet size is equal to 2^{m+1}.

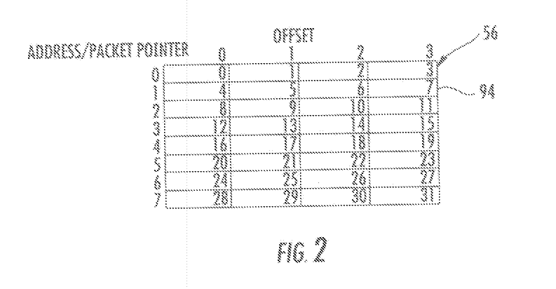

FIG. 2 schematically illustrates one example of memory of device 56 having 32 (0˜31) randomly accessible packet portions 94. Packet portions 94 are distributed amongst eight packets (0-7) such that each packet address is associated with four individual packet portions 94 identified by offset addresses. In other embodiments, memory device 56 may be provided with a greater or fewer number of such randomly accessible portions 94 distributed amongst a greater or fewer number of packets.

Processing unit 22 provides data to be written to memory device 56 and further controls or indicates where such data is to be written in each packet. In particular, processing unit 22 provides controller 50 with write increment signals via port 38 to increment the write address counter or pointer of controller 50. FIFO controller 50 indicates the current packet address for the particular data. In addition, processing unit 22 provides a write offset address via port 42 to indicate what particular randomly addressable portion of the packet is to have the data written to it. In circumstances where processing unit 22 receives a write full signal from controller 50, processing unit 22 delays transmission until later clock cycle.

Processing unit 24 receives data read from memory device 56 and further controls or indicates where such data is to be read from in each packet. In particular, processing unit 24 provides controller 50 with read increment signals via port 40 to increment the read address counter or pointer of controller 50. Controller 50 indicates the current packet address to be read. In addition, processing unit 24 provides a read offset address via port 44 to indicate what particular portion of the packet is to be read. In circumstances where processing unit 24 receives a read empty signal from controller 50, processing unit 24 delays reading to a later clock cycle

For purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, processing units 22, 24 may be embodied as part of one or more application-specific integrated circuits (ASICs). Unless otherwise specifically notes, the controller is not limited to any specific combination of hardware circuitry and software, not to any particular source for the instructions executed by the processing unit.

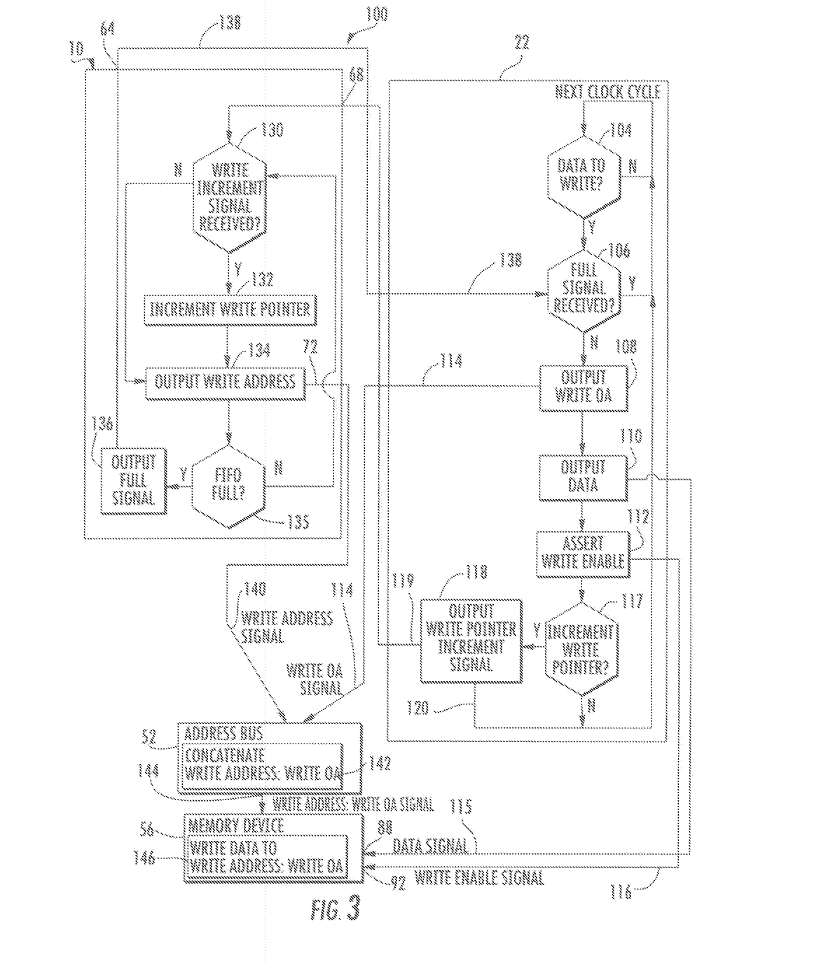

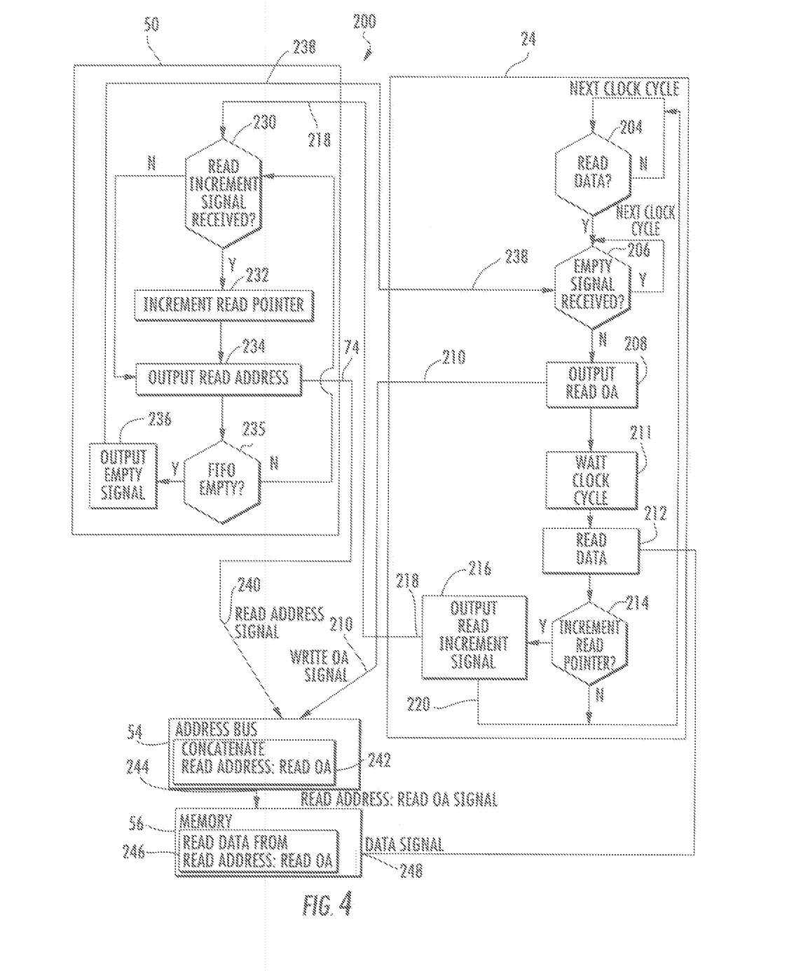

FIGS. 3 and 4 schematically illustrate data handling system 10 and flow diagrams for components of the system 10. FIG. 3 illustrates a method 100 by which data handling system 10 writes and stores data. As indicated by step 104, processing unit 22 waits for a determination that data should be written to memory device 56. If no data is to be written, processing unit 22 once again makes the same determination upon a next or subsequent clock cycle. As indicated by step 106, if processing unit 22 determines that data is to be written to memory device 56, processing unit 22 verifies whether or not a write full signal has been received from FIFO controller 50. If processing unit 22 has received a full signal such that the full flag is active, processing unit 22 delays further action towards writing the data until at least the next clock cycle.

In steps 108-112, processing unit 22 outputs signals for writing data. As indicated by step 108, processing unit 22 outputs a write offset address. The write offset address is the particular randomly accessible location or portion of a packet of data where such data is to be written. As indicated by line 114, the write offset address signal is transmitted to address bus 52 via port 42 (shown in FIG. 1). As indicated by step 110, processing unit 22 further outputs data signals (represented by line 115) which are transmitted to memory device 56 and received by memory device 56 at write data input 88. As indicated by step 112, processing unit 22 asserts a write enable signal (represented by line 116) which is transmitted to memory device 56 via write enable port 49 (shown in FIG. 1) and write enable input 92.

As indicated by step 117 after data has been output for writing to a particular portion of a packet address, processing unit 22 determines if additional data is to be written to other portions of the same packet address or if data is to be written to subsequent packet addresses by incrementing a write pointer of controller 50. As indicated by step 118, if processing unit 22 determines that the write pointer should be incremented (the data should be written to the next or a subsequent packet rather than a particular offset address within a packet), processing unit 22 outputs a write pointer increment signal. As represented by line 119, the write pointer increment signal is transmitted via write increment port 38 and is received by controller 50 at write increment input 68.

As indicated by line 120, once a decision has been made not to increment the write pointer or after the write pointer has been incremented, processing unit 22 returns to step 104 waiting for a signal indicating that data is once again to be written to memory device 56

As shown in FIG. 3, controller 50 provides write address signals to address bus 52 in a predetermined timed fashion based upon clock signals received via write clock port 30 and write clock input 60 (shown in FIG. 1). As indicated by step 130, controller 50 determines whether a write increment signal has been received from processing unit 22. If a write increment signal has been received via write increment port 38 and write increment input 68 (shown in FIG. 1), controller 50 increments the write pointer, counter or address as indicated in step 132. As a result, the next address signal provided by controller 50 will be incremented to a subsequent packet address. Alternatively, if a write increment signal has not been received, controller 50 skips step 132 and proceeds to outputting a write address as indicated by step 134. The write address, represented by line 140, is transmitted to address bus 52 via write address output 72.

As indicated by step 135, once a write address has been output in step 134, controller 50 determines whether memory device 56 (the buffer) if full. As indicated by step 136, if it is determined that memory device 56 is full, controller 50 outputs a “full” signal, represented by line 138. The full signal is output via write full output 64 and write full port 34 (shown in FIG. 1). As noted above, if processing unit 22 has received a full signal or is full status flag is active, processing unit 22 delays incrementing the write pointer until at least the next clock cycle.

As indicated by step 142, address bus 52 concatenates to receive write address signal and the received write offset address signal. The concatenated signal, represented by line 144, is transmitted to memory device 56 through input 84. As indicated by step 146 the data received via data signal 124 is written to memory device 56 at the concatenated address 144.

Because data handling system 10 provides randomly accessible portions in each packet being written in the FIFO scheme, data handling system 10 may be used in implementations to reduce buffering of data during certain write operations. For example, packetized data sometimes includes information regarding the seize or content of the packet at an initial field or early field of the packet. Unfortunately, the size of a packet may not be determinable unit substantially all of the packet fields or data has been received. As a result, substantially all of the fields and all of the packet must be first received and collected or buffered a first time while the size of the packet is being determined followed by buffering the packet a second time as it is being rewritten for transmission with the initial field of the packet now having the size of the packet written to it. This duplicate buffering adds processing cost and time.

Method 100 allows this first buffering process to be omitted. Because method 100 allows portions of a packet to be randomly accessed, the data may be packetized as it is being initially received. Upon receiving the last field of a packet of data, the initial or early field of the packet may be randomly accessed such that the size of the packet may then be written to it. Furthermore since only the packet address changes, the packet data does not have to be copied from one clock domain to another. As a result, processing time and cost may be reduced.

FIG. 4 illustrates a method 200 by which data handling system 10 reads data from memory device 56. As indicated by step 204, processing unit 24 waits for a determination that data should be read from memory device 56. If no data is to be read, processing unit 24 once again and makes the same determination upon a next or subsequent clock cycle.

As indicated by step 206, if processing unit 22 determines that data is to be read from memory device 56, processing unit 22 verifies whether or not a read empty signal has been received from FIFO controller 50. If an empty signal has been received, processing unit 24 delays further steps toward reading of data until the next or a subsequent clock cycle when it once again checks whether an empty signal has been received. If the read pointer was not incremented in the previous clock cycle by step 216, and more data is to be read from the current packet, the waiting for a subsequent clock cycle is optional before proceeding to step 208. As indicated by step 206, if an empty signal has not been received (the empty flag is not raised or is not active), processing unit 24 proceeds to output a read offset address. The read offset address is the particular randomly accessible location or portion of a packet of data where such data is to be written. As indicated by line 210, the read offset address signal is transmitted to address bus 54 via port 44 (shown in FIG. 1).

As indicated by step 211, once a read offset address has been output, processing unit 24 waits or delays further action towards reading for at least one clock cycle to provide memory device 56 sufficient time to access and provide the data stored in specified address location. Upon expiration of the wait period in step 211, processing unit 24 proceeds with reading data from the selected address as indicated by step 212. Such data is received from memory device as indicated by line 248.

As indicated by step 214, processing unit 24 determines if additional data is to be read from other portions of the same packet address or if data is to be read from subsequent packet addresses by incrementing a read pointer of controller 50. As indicated by step 216, if processing unit 24 determines that the read pointer should be incremented (the data should be read from the next or a subsequent packet rather than a particular offset address within a packet), processing unit 24 outputs a read pointer increment signal. As represented by line 218, the read pointer increment signal is transmitted via read increment port 40 and is received by controller 50 at read increment input 70.

As indicated by line 220, once a decision has been made to not increment the read pointer or after the read pointer has been incremented, processing unit 24 returns to step 204 waiting for a signal indicating that data is once again to be read from memory device 56

As shown in FIG. 4, controller 50 provides read address signals to address bus 54 in a predetermined timed fashion based upon clock signals received via read clock port 32 and read clock input 62 (shown in FIG. 1). As indicated by step 230, controller 50 determines whether a read increment signal has been received from processing unit 24. If a read increment signal has been received via read increment port 40 and read increment input 70 (shown in FIG. 1), controller 50 increments the read pointer, counter or address as indicated in step 232. As a result, the next address signal provided by controller 50 will be incremented to a subsequent packet address. Alternatively, if a read increment signal has not been received, controller 50 skips step 232 and proceeds to outputting a read address as indicated by step 234. The read address, represented by line 240, is transmitted to address bus 54 via read address output 74.

As indicated by step 235, once a read address has been output in step 234, controller 50 determines whether memory device 56 (the buffer) is empty in step 235. As indicated by step 236, if it is determined that memory device 56 is empty, controller 50 outputs an “empty” signal, represented by line 238. The empty signal is output via read empty output 66 and read empty port 36 (shown in FIG. 1). As noted above, if processing unit 24 has received an empty signal or an empty status flag is active, processing unit 24 delays incrementing the read pointer until at least the next clock cycle.

As indicated by step 242, address bus 52 concatenates the received read address signal and the received read offset address signal. The concatenated signal, represented by line 244, is transmitted to memory device 56. As indicated by step 246, the data at the concatenated address in memory device 56 is transmitted as a data signal, represented by line 248.

Method 200 permits portions of each packet to be selectively accessed in any order as needed. For example, in step 208, processing unit 24 determines whether data is to be read from the existing packet or a subsequent packet. In step 218, processing unit 24 selects a portion of the packet to be randomly or selectively accessed for reading. As a result, method 200 permits processing unit 24 to jump or skip to particular portions or data fields of a packet, as addressed by a particular offset address, and to read data from such particular portions of a packet to determine how much of the particular packet should be read.

For example, in a particular writing scheme, certain important data may be assigned to a particular filed or data portion of a packet. In such a scenario, processing unit 24, following computer readable instructions, may output a read offset address in step 218 corresponding to the data portion of the packet that is supposed to contain the important data. If, upon reading the particular data portion as addressed by the offset address output at step 210, processing unit 24 determines that the particular data field is empty or corrupted, processing unit 24 may automatically skip to the next successive packet of data in memory device 56 by incrementing the read pointer in step 216 without reading the remaining other portions of the packet (represented by other offset addresses for the packet). As a result, processing time and resources are not wasted reading data from other portions of a packet that may have little or no value without the data that was missing from the first read packet portion or that was corrupted.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. In addition, unless otherwise denoted, method steps may be interchanged or performed concurrently. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. A method comprising:
identifying a write packet of data in a memory using a first-in, first-out (FIFO) write counter;
writing a selected randomly accessible portion of the write packet;
identifying a read packet of data in a memory using a first-in, first-out (FIFO) read counter; and
reading a selected randomly accessible portion of the read packet.

2. The method of claim 1 further comprising skipping reading other unread portions of the packet based on a content of the read portion of the packet.

3. The method of claim 2, wherein skipping comprise incrementing or advancing the FIFO read address counter.

4. The method of claim 2 further comprising skipping reading of entire subsequent packets based on content of the read portion of the packet.

5. The method of claim 1 further comprising writing the packet of data to memory from a first domain having a first clock frequency, wherein the selected portion of the data is read to a second domain having a second clock frequency different than the first clock frequency or the same clock frequency but out of phase.

6. The method of claim 1, wherein the read counter includes a packet counter value and offset value concatenated to one another.

7. The method of claim 6, wherein the packet counter value is in a Gray code format.

8. The method of claim 6, wherein the packet counter value is in a binary format.

9. The method of claim 6 further comprising incrementing or advancing the packet counter value prior to reading at least one other unread packet portion based on content of the read packet portion.

10. The method of claim 9, wherein incrementing the packet counter is by one increment.

11. The method of claim 9, wherein incrementing the packet counter is by a plurality of increments.

12. The method of claim 6, wherein the packet includes a plurality of portions including the selected portion and wherein each portion of the packet is addressed by an offset value.

13. The method of claim 1 further comprising:
partitioning a packet of data into a plurality of packet portions; and
writing each packet portion to the memory, each packet portion being addressed with a packet counter value concatenated with an offset value addressing the packet portion.

14. The method of claim 1 further comprising:
writing to a first randomly accessible portion of a packet a first time;
writing to the randomly accessible first portion of the packet a second time after writing to a randomly accessible second portion of the packet.

15. The method of claim 1 comprising selecting a randomly accessible portion of a packet and writing a size of the packet to the portion of the packet.

16. A method comprising:
partitioning a packet of data into a plurality of packet portions; and
writing each packet portion to the memory, each packet portion being addressed with a packet counter value concatenated with an offset value addressing a portion of the packet.

17. The method of claim 16 further comprising reading the packet from the memory in a first-in, first-out (FIFO) order.

18. The method of claim 16 further comprising:
writing a first time to a first portion of a packet;
writing to a second portion of a packet; and
writing to the first portion of the packet a second time following the writing to the second portion.

19. An apparatus comprising:
a first-in, first out (FIFO) controller configured to provide a packet write address signal and a packet read address signal;
a write offset input configured to provide an offset write address signal identifying a portion of a packet to be written;
a first address bus concatenating the packet write address signal and the offset write address signal;
a read offset input configured to provide an offset read address signal identifying a portion of a packet to be read;
a second address bus concatenating the packet read address signal and the offset read address signal; and
a memory having a write address port receiving the concatenated write address signal and a read address port receiving the concatenated read address signal.

20. The apparatus of claim 19, wherein the FIFO controller includes a read increment port and wherein apparatus further comprises a processing unit configured to selectively provide different FIFO increment signals representing different non-zero increments to the read increment port.
